(19) United States
(12) Patent Application Publication
(10) Pub. No.: US 2013/0173456 A1
(43) Pub. Date: Jul. 4, 2013

(54) PRESENTATION OF MOBILE PAYMENT TRANSACTIONHISTORY ON A MOBILE COMMUNICATION DEVICE

(71) Applicants: David M. Grigg, Roch Hill, SC (US); John Franklin Tuders, Harrisburg, NC (US); Peter John Bertanzetti, Charlotte, NC (US); Tony England, Tega Cay, SC (US)

(72) Inventors: David M. Grigg, Roch Hill, SC (US); John Franklin Tuders, Harrisburg, NC (US); Peter John Bertanzetti, Charlotte, NC (US); Tony England, Tega Cay, SC (US)

(73) Assignee: Bank of America Corporation, Charlotte, NC (US)

(21) Appl. No.: 13/342,082

(22) Filed: Jan. 1, 2012

(51) Int. Cl. G06Q 40/00

(52) U.S. Cl. 705/39; 705/35

(57) ABSTRACT

Embodiments of the present invention relate to systems, apparatus, methods and computer program products for providing users/customers instantaneous access to mobile payment transaction history data. As such the mobile payment user can track mobile payment spending and budget accordingly. In addition, embodiments provide for the user to search transaction history to identify specific mobile payment transactions for the purpose of identifying when, where and the amount of a prior mobile payment transaction. Moreover, the user is provided the ability to verify that no unauthorized transactions occurred in the event that the user re-acquires possession of a mobile payment device that was previously lost, misappropriated or misplaced, or, if unauthorized transactions did occur, the ability to quickly identify the location and amount of such unauthorized transactions.

### FIELD

In general, embodiments of the invention relate to commerce and, more particularly, providing users instantaneous access to mobile payment transaction history on the mobile communication device.

### BACKGROUND

Mobile payment, also referred to as “mobile wallet” is an alternative payment method that implements a mobile communication device, such as a mobile telephone, as the payment vehicle instead of using conventional means, such as cash, check, or credit cards. Currently, mobile payment includes multiple different models, such as, but not limited to, Short Message Service (SMS)/text-based transactional payments, direct mobile billing, mobile web payment and contactless payment (e.g., Near Field Communication (NFC) or the like). The combined market for all types of mobile payment is expected to reach more than $600 billion globally by 2013.

In an attempt to track spending and budget accordingly, mobile payment users have expressed a need to readily be made aware of where they have recently conducted mobile payment transactions and the amounts spent on such transactions. In addition to desiring knowledge on where mobile payment transactions have been conducted and the amount of such transactions, mobile payment users further have a desire to search for or otherwise identify specific transactions as a means of determining where a transaction was conducted and/or the amount of the transaction.

In addition to having a desire for instantaneous access to mobile transaction history data, users of mobile payment devices have a desire to quickly verify that no unauthorized and/or fraudulent mobile payment transactions have occurred once they re-acquire possession of a mobile payment device that was lost, stolen or misplaced. In the event, that unauthorized of fraudulent transactions did occur while the mobile payment device was out of the possession of the user, the user has the desired to readily identify where and when such transactions occurred for the purpose of assisting in identifying the perpetrator.

Therefore, a need exists to provide mobile payment users instantaneous access to mobile payment transaction history. In addition, a desired need exists to provide mobile payment users the ability to identify specific mobile payment transactions for the purpose of identify when, where and the amount of a previous transaction. Moreover, a desired need to exists to provide the mobile payment user immediate verification that no unauthorized mobile payment transactions have occurred once the user re-acquires possession of a mobile payment device or, if unauthorized payments have occurred the ability to immediate determine the location of such unauthorized purchases.

### SUMMARY

The following presents a simplified summary of one or more embodiments in order to provide a basic understanding of such embodiments. This summary is not an extensive overview of all contemplated embodiments, and is intended to neither identify key or critical elements of all embodiments, nor delineate the scope of any or all embodiments. Its sole purpose is to present some concepts of one or more embodiments in a simplified form as a prelude to the more detailed description that is presented later.

Embodiments of the present invention relate to systems, apparatus, methods, and computer program products for providing mobile payment users instantaneous access to mobile payment transaction history data. Such mobile payment transaction history data is beneficial to the mobile payment user as a means of tracking spending and budgeting accordingly. In addition, such data provided in a searchable format, allows the user to identify specific mobile payment transactions for the purpose of identifying when, where and the amount of a prior mobile payment transaction.

In addition, such mobile payment transaction history data provides the user verification that no unauthorized transactions occurred in the event that the user reacquires possession of a mobile payment device that was previously lost, stolen or misplaced, or, if unauthorized transactions did occur, the ability to quickly identify the location and amount of such unauthorized transactions.

A method for presenting transaction history on a mobile communication device defines first embodiments of the invention. The method includes accessing, via the mobile communication device, a payment database that includes transaction history data associated with a user of the mobile communication device and identifying, from the transaction history data, mobile payment transactions conducted by the user using the mobile communication device. The method further includes presenting, via a user interface on the mobile communication device, transaction data associated with at least a portion of the identified mobile payment transactions.

In specific embodiments of the method, identifying further includes identifying, from the transaction history data, a predetermined number of mobile payment transactions conducted most recently by the user and presenting further including presenting, via a user interface on the mobile communication device, transaction data associated with the predetermined number of mobile payment transactions.

In further specific embodiments of the method, identifying further includes identifying, from the transaction history data, mobile payment transactions conducted by the user at a specified merchant and presenting further includes presenting, via a user interface on the mobile communication device, transaction data associated with at least a portion of the mobile payment transactions conducted by the user at the specified merchant. In such embodiments of the method, the specific merchant may be identified based on user input, or be determining that the user is proximate in location to the specific merchant or determining that the user has immediately conducted a transaction at the specified merchant.

In still further specific embodiments of the method, identifying further includes identifying, from the transaction history data, any transactions conducted by the user (e.g., credit, debit, demand account) and wherein presenting further includes presenting, via a user interface on the mobile communication device, transaction data associated with at least a portion of the transactions conducted by the user. In such embodiments of the method, the identified transactions may be transactions conducted by the user at a specified merchant. The specific merchant may be identified based on user input, or by determining that the user is proximate in location to the specific merchant or by determining that the user has immediately conducted a transaction at the specified merchant.

In other specific embodiments of the method, identifying further includes identifying, from the transaction history data, mobile payment transactions occurring over a user-defined date range and presenting further includes presenting, via a user interface on the mobile communication device, transaction data associated with at least a portion of the mobile payment transactions occurring over the user-defined date range. In still other embodiments of the method, identifying further includes identifying, from the transaction history data, mobile payment transactions within a user-defined price range or price limit and presenting further includes presenting, via a user interface at the mobile communication device, transaction data associated with at least a portion of the mobile payment transactions within the user-defined price range or price limit.

In additional embodiments the method includes presenting, via a user interface on the mobile communication device, a map that is configured to indicate a location for each of the identified mobile payment transactions.

An apparatus for providing transaction history on a mobile communication device provides second embodiments of the invention. The apparatus includes a payment database that includes transaction history data associated with a plurality of users. The apparatus further includes a mobile communication device including a memory, at least processor in communication with the memory and a user interface in communication with the memory and processor. In addition, the mobile communication device includes a mobile payment application stored in the memory, executable by the processor and configured to act as a payment vehicle for conducting transactions. Moreover, the mobile communication device includes a transaction presentation application stored in the memory and executable by the processor. The transaction presentation application is configured to access the payment database to identify, from the transaction history data, mobile payment transactions conducted by the user using the mobile payment application and present, via the user interface, transaction data associated with at least a portion of the identified mobile payment transactions.

In specific embodiments of the apparatus, the transaction presentation application is further configured to access the payment database to identify, from the transaction history data, a predetermined number of mobile of mobile transactions conducted most recently by the user and present, via the user interface, transaction data associated with the predetermined number of identified mobile payment transactions.

In other specific embodiments of the apparatus, the transaction presentation application is further configured to access the payment database to identify, from the transaction history data, mobile payment transactions conducted by the user at a specified merchant and present, via the user interface, transaction data associated with at least a portion of the mobile payment transactions conducted by the user at the specified merchant. In such embodiments, the transaction presentation application may be further configured to identify the specified merchant by user input. In other embodiments, the mobile communication device may include a location determining device executable by the processor and configured to determine that the user is proximate in location to the specified merchant. In such embodiments the transaction presentation application may be further configured to automatically launch and provide presentation of the transaction data based on determining that the user is proximate in location to the specified merchant. In other embodiments, the transaction presentation application may be further configured to receive an indication that the user has immediately conducted a mobile payment transaction at the specified merchant. In such embodiments, the transaction presentation application may further configured to automatically launch and provide presentation of the transaction data based on receiving an indication that the user has immediately conducted a mobile payment transaction at the specified merchant.

In other embodiments of the apparatus, the transaction presentation application is further configured to access the payment database to identify, from the transaction history data, any transactions (e.g., credit, debit, demand account or the like) conducted by the user and present, via the user interface, transaction data associated with at least a portion of the transactions conducted by the user. In such embodiments, the transaction presentation application may be further configured to access the payment database to identify, from the transaction history data, any transactions conducted by the user at a specified merchant and present, transaction data associated with at least a portion of the transactions conducted by the user at the specified merchant. In such embodiments, the specified merchant may be identified based on user input, or determining that the user is proximate in location to the specific merchant or determining that the user has immediately conducted a transaction at the specified merchant. In such embodiments of the apparatus, the transaction presentation application may be further configured to automatically launch and provide presentation of the transaction data based on the user input, determining that the user is proximate in location to the specified merchant, or determining that the user has immediately conducted a transaction at the specified merchant.

In further embodiments of the apparatus, the transaction presentation application is further configured to access the payment database to identify, from the transaction history data, mobile payment transactions occurring over a user-defined date range and present, via the user interface, transaction data associated with at least a portion of the mobile payment transactions occurring over the user-defined date range. While in other embodiments of the apparatus, the transaction presentation application is further configured to access the payment database to identify, from the transaction history data, mobile payment transactions within a user-defined price range or price limit and present, via the user interface, transaction data associated with at least a portion of the mobile payment transactions within the user-defined price range or price limit.

In still further specific embodiments of the apparatus, the transaction presentation application is further configured to present a map that is configured to indicate a location for each of the identified mobile payment transactions.

A computer program product defines third embodiments of the invention. The computer program product includes a non-transitory computer-readable medium having computer-executable instructions to cause a computer to implement the steps of (1) accessing a payment database that includes transaction history data associated with a user of a mobile communication device, (2) identifying, from the transaction history data, mobile payment transactions conducted by the user using the mobile communication device; and (3) presenting, via user interface on the mobile communication device, transaction data associated with at least a portion of the identified mobile payment transactions.

Thus, further details are provided below for systems, apparatus, methods and computer program products for providing users/customers instantaneous access to mobile payment transaction history data. As such the mobile payment user can track mobile payment spending and budget accordingly. In addition, embodiments provide for the user to search transaction history to identify specific mobile payment transactions for the purpose of identifying when, where and the amount of a prior mobile payment transaction. Moreover, the user is provided the ability to verify that no unauthorized transactions occurred in the event that the user re-acquires possession of a mobile payment device that was previously lost, stolen or misplaced, or, if unauthorized transactions did occur, the ability to quickly identify the location and amount of such unauthorized transactions.

To the accomplishment of the foregoing and related ends, the one or more embodiments comprise the features hereinafter fully described and particularly pointed out in the claims. The following description and the annexed drawings set forth in detail certain illustrative features of the one or more embodiments. These features are indicative, however, of but a few of the various ways in which the principles of various embodiments may be employed, and this description is intended to include all such embodiments and their equivalents.

### BRIEF DESCRIPTION OF THE DRAWINGS

Reference will now be made to the accompanying drawings, which are not necessarily drawn to scale, and wherein:

FIG. 1 is a block diagram of a system for providing access to mobile payment transaction data on a mobile communication device, in accordance with an embodiment of the present invention;

FIG. 2 is a block diagram of a mobile communication device configured to provide access to transaction data, in accordance with embodiments of the present invention;

FIG. 3 is an example of a mobile communication display presenting a user interface for transaction presentation configuration, in accordance with embodiments of the present invention;

FIG. 4 is an example of a mobile communication device presenting a user interface for transaction presentation selection criteria, in accordance with embodiments of the present invention;

FIG. 5 is an example of a mobile communication device presenting transaction data, in accordance with embodiments of the present invention; and

FIG. 6 is a flow diagram of a method for presenting mobile payment transaction data on a mobile communication device, in accordance with embodiments of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. In the following description, for purposes of explanation, numerous specific details are set forth in order to provide a thorough understanding of one or more embodiments. It may be evident; however, that such embodiment(s) may be practiced without these specific details. Like numbers refer to like elements throughout.

Various embodiments or features will be presented in terms of systems that may include a number of devices, components, modules, and the like. It is to be understood and appreciated that the various systems may include additional devices, components, modules, etc. and/or may not include all of the devices, components, modules etc. discussed in connection with the figures. A combination of these approaches may also be used.

The steps and/or actions of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium may be coupled to the processor, such that the processor can read information from, and write information to, the storage medium. In the alternative, the storage medium may be integral to the processor. Further, in some embodiments, the processor and the storage medium may reside in an Application Specific Integrated Circuit (ASIC). In the alternative, the processor and the storage medium may reside as discrete components in a computing device. Additionally, in some embodiments, the events and/or actions of a method or algorithm may reside as one or any combination or set of codes and/or instructions on a machine-readable medium and/or computer-readable medium, which may be incorporated into a computer program product.

In one or more embodiments of the present invention, the functions described may be implemented in hardware, software, firmware, or any combination thereof. If implemented in software, the functions may be stored or transmitted as one or more instructions or code on a computer-readable medium. Computer-readable media includes both computer storage media and communication media, including any medium that facilitates transfer of a computer program from one place to another. A storage medium may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures, and that can be accessed by a computer. Also, any connection may be termed a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. “Disk” and “disc”, as used herein, include compact disc (CD), laser disc, optical disc, digital versatile disc (DVD), floppy disk and blu-ray disc where disks usually reproduce data magnetically, while discs usually reproduce data optically with lasers. Combinations of the above should also be included within the scope of computer-readable media.

In general, embodiments of the present invention relate to systems, methods and computer program products for providing users/customers with users/customers instantaneous access to mobile payment transaction history data through presentation at the mobile communication device communication. As such the mobile payment user can track mobile payment spending and budget accordingly. In addition, embodiments provide for the user to search transaction history to identify specific mobile payment transactions for the purpose of identifying when, where and the amount of a prior mobile payment transaction. Moreover, the user is provided the ability to verify that no unauthorized transactions occurred in the event that the user re-acquires possession of a mobile payment device that was previously lost, stolen or misplaced, or, if unauthorized transactions did occur, the ability to quickly identify the location and amount of such unauthorized transactions.

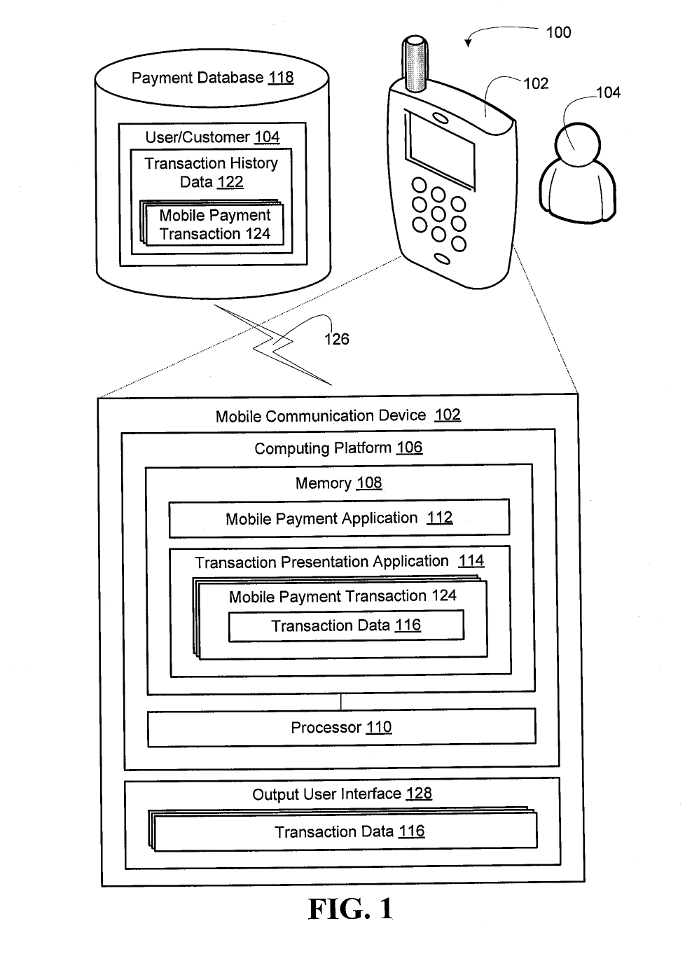

Referring to FIG. 1 a block diagram is depicted of a system 100 configured to provide instantaneous access to mobile payment transaction history, in accordance with an embodiment of the present invention. The system includes mobile communication device 102 that is in the possession of user 104, otherwise referred to herein as a customer or the individual conducting the transactions. The mobile communication device 102, such a mobile telephone or the like, includes a computing platform 106 having a memory 108 and a processor 110. The memory 108 of mobile communication device 102 stores mobile payment application 112, referred to herein or otherwise as a mobile wallet application, mobile money application or the like. The mobile payment application 112 is configured to allow the user 104 to conduct mobile payment transactions using the mobile communication device 102. As previously discussed mobile payment allows the user/customer 104 to implement the mobile communication device 102 as the payment vehicle, as opposed to using cash, checks, credit cards, debit cards or the like.

The memory 108 of mobile communication device 108 also includes transaction presentation application 114 which is configured to present historical transaction data 116 on the mobile communication device 102. In specific embodiments, the transaction presentation application 114 is configured to be launched at the request of the user 104, such as when the user desires to see or otherwise be presented with historical transaction data 116. The user may enter a keypad stroke, a touch screen input to launch the application or the application may be configured to launch by voice command. In other specific embodiments of the invention, the transaction presentation application 114 is configured to be launched upon occurrence of a predetermined event. The predetermined events, which are discussed in more detail infra, may include, but are not limited to, conducting a transaction, close proximity to a user designated merchant or previously used merchant, attaining or close proximity to user designated spending limits, account balance thresholds or the like.

Once the transaction presentation application 114 is launched, it is configured to access a payment database 118 that includes transaction history data 122 associated with the user 104; including data associated with mobile payment transactions 124. In the embodiment shown in FIG. 1, the payment database 118 is a remote database that is accessed though wireless communication 126 between the mobile communication device 102 and the network device (not shown in FIG. 1) storing the payment database 118. In such embodiments, the transaction history data 122 may be configured to store all or a portion of the transaction history data 122 associated with the user 104, such as mobile payment transaction data, credit card transaction data, debit card transaction data, checking transaction data or the like. Thus, in such embodiments, if the transaction presentation application 114 is tasked with presenting only mobile payment transaction data, the mobile payment transactions 124 are identified within the payment database 118 are communicated to the transaction presentation application 114. In alternate embodiments the payment database 118 may be limited to a specific payment vehicle, for example, a mobile payment database, such that all the transaction history data 122 included in the payment database is data of the specific payment vehicle type, for example mobile payment transactions 124 only.

In other embodiments of the invention, the payment database 118 may be stored locally within the memory 108 of the wireless communication device 102. For example, if the payment database 118 is limited to a mobile payment database, the database may locally store transaction history data 122 associated with the most recent mobile payment transactions 124.

Once the payment database 118 has been accessed and the transactions requested to be presented on the mobile communication have been identified, the mobile presentation application 114 is further configured to present transaction data 116 associated with the mobile payment transactions 124 on a output user interface 128, such as a display, speaker or the like, of the mobile communication device 102. The transaction data 116 may include, but is not limited to, the merchant/retailer at which the transaction was conducted, the date/time of the transaction, the amount of the transaction, items included in the transaction and the like.

In one specific embodiment of the invention the transaction data 116 associated with predetermined number of most recent mobile payment transactions is presented on the output user interface 128. The predetermined number of transactions presented may be determined by the application 114 or by the user 104. In the event that the predetermined number of transactions is determined by the application 114, the application may take into account the geometry of the display in determining how many transactions may be displayed within the viewable area of the display. In other embodiments of the invention, in which presentation of transaction data 116 is not limited to single display/page on the mobile communication display 102, the presentation of transaction data may not be limited in terms of a specific number of transactions. For example, a scrollable display of transaction data 116 may provide for more transaction data 116 to be presented than a single display/page of transaction data 116 could afford.

In one specific embodiment of the invention, the transaction data 116 may be presented in chronological order, such the transaction data 116 associated with the most recent transaction is presented first. In such embodiments, the transaction presentation application 102 may be configured to allow for re-ordering the presentation of the transaction data (i.e., sort functionality) in terms of transaction amount, alphabetic ordering of the merchant names or the like. Additionally, in additional embodiments, a search function may be provided in conjunction with the presentation of the transaction data 116, such that a user may enter a merchant name, an item name/description, a date/time, and/or transaction return and the application 114 may be present results of the search or the transaction data 116 associated with the search results may be presented first amongst the transaction data 116 presented/displayed.

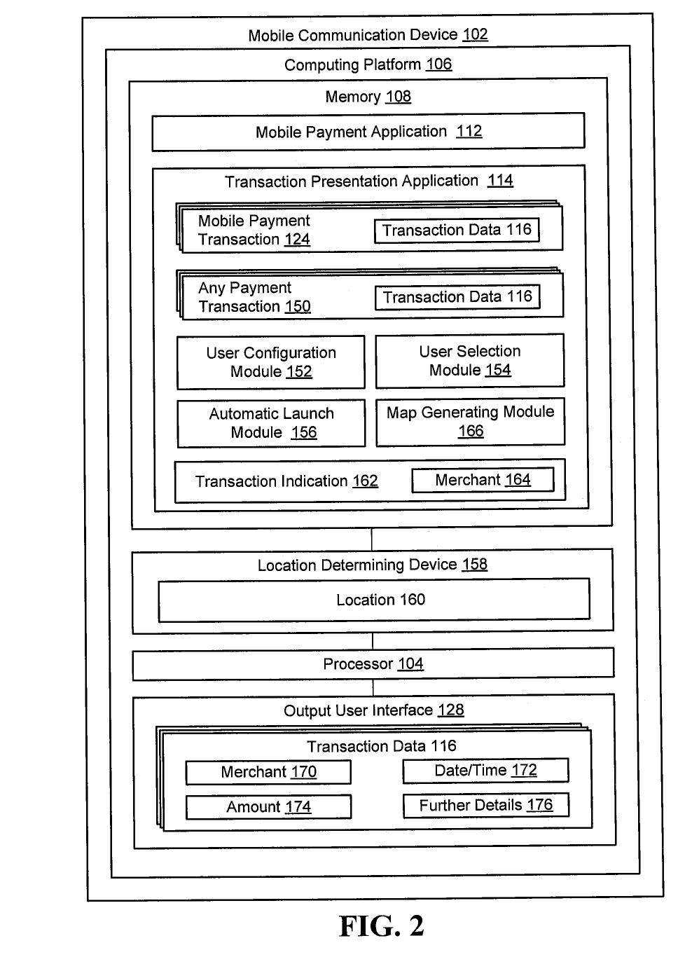

FIG. 2 provides a block diagram of a mobile communication device 102 that includes various alternate embodiments of the present invention. Similar to the wireless communication device shown and described in FIG. 1, the mobile communication device 102 includes a computing platform 106 having a memory 108 and at least one processor 110 in communication with the memory 108. The mobile communication device 102 may include any type of handheld communication device capable of implementing mobile payment, for example, a mobile/cellular smart telephone or the like. The computing platform 106 is operable to receive and execute modules, routines and applications, such as mobile payment application 112, transaction presentation application 114 and the like. Memory 108 may comprise volatile and nonvolatile memory such as read-only and/or random-access memory (RAM and ROM), EPROM, EEPROM, flash cards, or any memory common to computing platforms. Further, memory 108 may include one or more flash memory cells, or may be any secondary or tertiary storage device, such as magnetic media, optical media, tape, or soft or hard disk.

Further, computing platform 106 also includes processor 110, which may be an application-specific integrated circuit (“ASIC”), or other chipset, processor, logic circuit, or other data processing device. Processor 110 or another processor such as an ASIC may execute an application programming interface (“API”) layer (not shown in FIG. 2) that interfaces with any resident programs, such as mobile payment application 112, transaction presentation application 114 and the like, stored in the memory 108 of mobile communication device 102. Processor 110 may include various processing subsystems (not shown in FIG. 2) embodied in hardware, firmware, software, and combinations thereof, that enable the functionality of mobile communication device 102 and the operability of the device on a wireless network. For example, processing subsystems allow for initiating and maintaining communications, and exchanging data, with other networked devices. It should be noted that any of the modules, sub-modules, and routines shown and described as being stored in memory 108 may alternatively be embodied in processing subsystems.

As previously described, the memory 106 of mobile communication device 102 includes mobile payment application 112, otherwise referred to as a mobile wallet application, mobile money application or the like. The mobile payment application 112 is configured to allow the user 104 to conduct mobile payment transactions using the mobile communication device 102. In specific embodiment, in which the mobile payment application requires secure close-range wireless communication, additional hardware may be required by the mobile communication device 102, for example, a Near Field Communication (NFC) chip (not shown in FIG. 2) or the like.

Moreover, the memory 106 of mobile communication device 102 includes transaction presentation application 112 which is configured to access a payment database (118 of FIG. 1) to identify, from transaction history data stored in the database, mobile payment transactions 124 conducted by the user using the mobile communication device 102 as the payment vehicle. Once the mobile payment transactions 124 have been identified, the transaction presentation application is further configured to present, via the output user interface 128, transaction data 116 associated with at least a portion of the identified mobile payment transactions 124.

In alternate embodiments of the invention, the transaction presentation application 112 may be configured to present transaction data 116 associated with any payment transaction 150 conducted by the user. Such payment transactions may include, debit account transactions, credit account transactions, checking/demand deposit account transactions, pre-paid account transactions and the like. In such embodiments, the transaction presentation application 112 accesses a payment database to identify, from the transaction history data stored in the database, transactions conducted by the user. In such embodiments in which the application is configured to present transaction data 116 associated with any payment transaction, the user may configure the application to present the desired transaction data based on one or more user-selected payment transaction types.

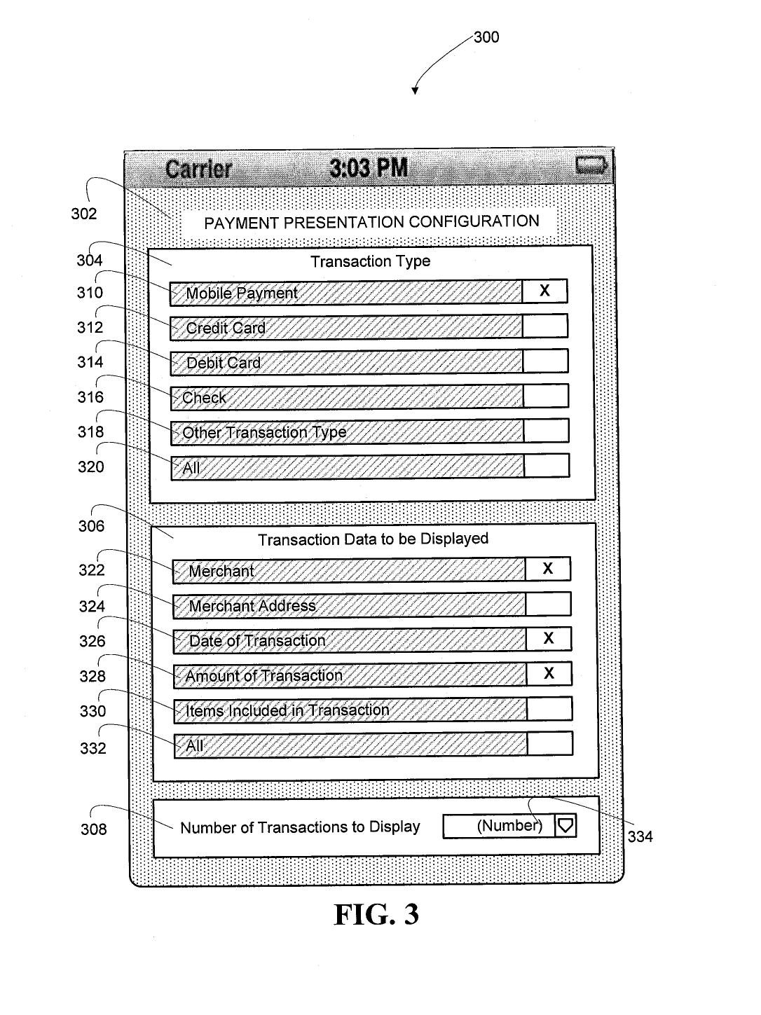

In this regard, the transaction presentation application 102 may include user configuration module 152 that is configured to allow the user to configure parameters related to the presentation of transaction data 116. Referring to FIG. 3 a graphical representation of mobile communication device display 300 configured to display payment presentation configuration 302 is shown, in accordance with embodiments of the present invention. The payment presentation configuration may be accessed by the user for the purpose of configuring the subsequent presentation of transaction data on the mobile communication device. The configurable parameters displayed in payment presentation configuration 302 include transaction type 304, transaction data to be displayed 306 and the number of transactions to display 308. It should be noted that the configurable parameters shown are by way of example only and more or less parameters may be included within payment presentation configuration 302.

The transactions type 304 selections include mobile payment 310, credit card/account 312, debit card/account 314, checking/demand deposit account 316, other transaction type 318 and “all” 320. The user may select one or more transaction types by checking the check box associated with specific transaction type. Selection of “all” transaction type provides for presentation of all the payment transaction types listed. It should be noted that in the event the user chooses more than one transaction type 304, the presentation of the transaction data may include the transaction type. The transaction type may be identified in the presentation by a field stating the transaction type or the transaction type may be highlighted or otherwise coded to indicate transaction type.

The transaction data to be displayed 306 selections include merchant 322, merchant address 324, date of transaction 326, amount of transaction 328, items included in the transaction 330 and “all” 332. The user may select one or more of the transaction data to be displayed by checking the check box associated with the specific transaction data item. Selection of “all” provides for presentation of all the transaction data items listed. It should be noted that in instances in which the user has configured for all or most of the transaction data items to be presented, the number of transactions chosen to be presented and/or the size of the display may be prohibit all of the transaction data items from being displayed simultaneously. In such an event, certain items may be presented by activating or hovering over another transaction data item. For example, merchant address may be presented by activating or hovering over the merchant name, items included in the transaction may be presented by activating or hovering over the transaction amount and the like.

Additionally, the display payment presentation configuration 302 may include number of transaction to display 308 which allows the user to choose, from the drop down menu 340 the number of transactions that the user desires to display. The drop down menu may additionally include an option which provides for the user to select “all” as the number of transactions to display. Such a selection may provide for presentation of all the transactions within the selected transaction type that have occurred within a specified time frame, for example, within the past 60 days, the past 6 months, the past year or the like.

In alternate embodiments of the invention, the application 114 may be configured to allow for voice commands to be received from the user as the means for configuring the presentation of transaction data on the mobile communication device. For example, voice commands may indicate the type of transactions to be presented, the type of transaction data to be presented and the number of transactions to be presented.

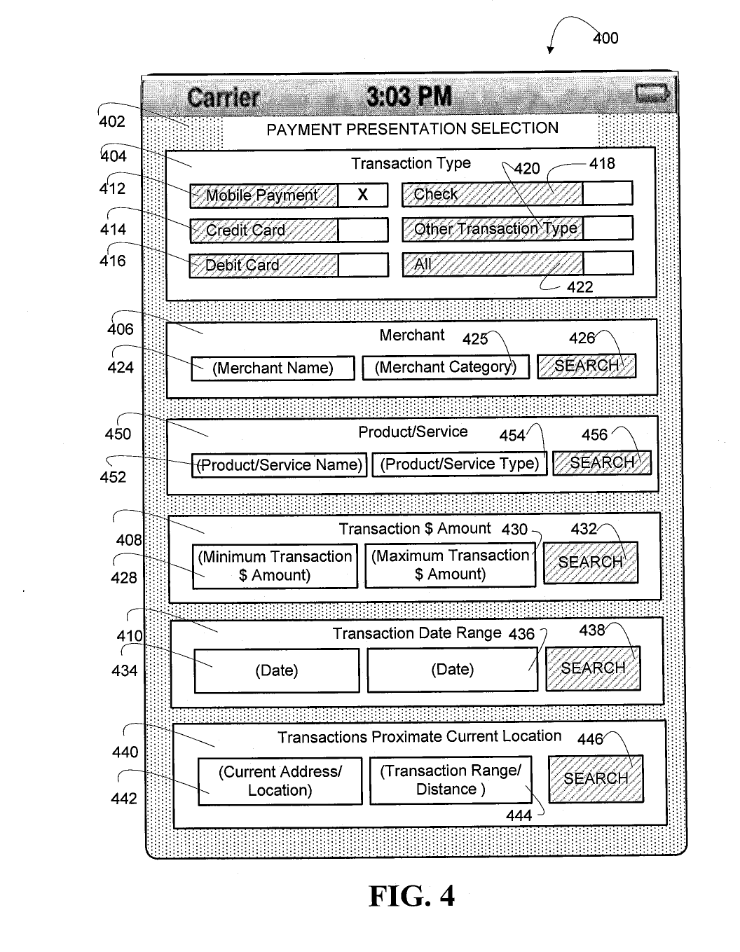

Referring again to FIG. 2, in other embodiments of the invention, the transaction presentation application 114 is configured to allow the user to select, upon launch of the application, the payment transaction types for the impending presentation of transaction data 116. In such embodiments, the transaction presentation application 114 includes user selection module 154 which is configured to allow the user to select presentation criteria for the impending presentation of transaction data 116. Referring to FIG. 4 a graphical representation of mobile communication device display 400 configured to display payment presentation selections 402 is shown, in accordance with embodiments of the present invention. The payment presentation selections 402 may be displayed to the user upon launch of the application 114 or otherwise accessible to the user for defining presentation criteria. The presentation criteria displayed in payment presentation selections 402 include transaction type 404, product/service 450, merchant 406, transaction amount 408, transaction date range 410 and transactions proximate current location 440. It should be noted that the presentation criteria shown are by way of example only and more or less presentation criteria may be included within payment presentation selection 402.

The transactions type 404 selections include mobile payment 412, credit card/account 414, debit card/account 416, checking/demand deposit account 418, other transaction type 420 and “all” 422. The user may select one or more transaction types by checking the check box associated with specific transaction type. Selection of “all” transaction type provides for presentation of all the payment transaction types listed. Selection of transaction type within the presentation selection 402 display, will serve to override the selection of the transaction type in the configuration module 152 for the impending presentation of transaction data.

The merchant 406 selection allows the user to enter a specific merchant name in the merchant entry field 424 and, upon activating the search button 426, returns a presentation of all of the transaction data 116 associated with transactions conducted by the user at the selected merchant. As an alternative to selecting a merchant, the merchant 406 selection may provide for entering a merchant category in the merchant category field 425 or selecting a merchant category from a drop down window (not shown in FIG. 4) and, upon activating the search button 426, returns a presentation of all of the transaction data 116 associated with transactions conducted by the user at merchant's within the merchant category.

The product/service 450 selection allows the user to enter a specific product/service by name or designator (such as, code or the like) in the product/service entry field 452 and, upon activating the search button 456, returns a presentation of all of the transaction data 116 associated with transactions conducted by the user for the selected product or service. As an alternative to selecting a product/service, the product/service 450 selection may provide for entering a product/service category in the product/service category field 454 or selecting a product/service category from a drop down window (not shown in FIG. 4) and, upon activating the search button 426, returns a presentation of all of the transaction data 116 associated with transactions conducted by the user within the product/service category.

The transaction amount 408 selection allows the user to enter a specific minimum transaction amount in the minimum transaction amount field 428 and/or maximum purchase amount in the maximum transaction amount field 430 and, upon activation of the search button 432, returns a presentation of all transactions within the transaction amount range or above the minimum transaction amount or below the transaction maximum amount, as limited by the selection or configuration of transaction type. In this regard, if both the minimum transaction amount field 428 and the maximum transaction amount field 430 have been filled in by the user, the application will return transactions within the transaction amount range, if only the minimum transaction amount field 428 has been filled in by the user, the application will return transactions above the minimum transaction amount and if the maximum transaction amount field 430 has been filled in by the user, the application will return transactions below the maximum transaction amount.

The transaction data range 410 selection allows the user to enter a specific data range or date in the date fields 430 and 432 and, upon activation of the search button 434, returns a presentation of all transactions within the date range or, if only one date is entered in the date field 430 or 432, all transactions occurring on that specific date, as limited by the selection or configuration of transaction type.

The transactions proximate current location 440 selection allows the user to enter their current location or address in the address/location field 442 and, upon activation of the search button 446, returns a presentation of all transactions occurring proximate (i.e., within a predetermined distance/radius of the current location) the current location. The transactions may be presented such that the transaction closest in distance in presented first or the transactions may be presented in any other order, such as alphabetical based on the name of the merchant. In alternate embodiments, the presentation may provide for sorting the transactions in terms of sort criteria, such as closest in distance, date, merchant name, transaction amount and the like. In alternate embodiments, in which the mobile device is configured with a location-determining device, such as a Global Positioning System (GPS) device or the like or is equipped with other means of determining the current location absent user entry (e.g., location based on cellular signals, triangulation or the like), the need to enter the current location is obviated. In such, embodiments, the transaction proximate current location 440 selection may be limited to the search button 446. In addition, the transactions proximate current location 440 selection may include a transaction range/distance field 444 operable to allow the user to enter the distance or range for which transactions should be presented (e.g., within one mile, within five miles, within fifty miles or the like).

In alternate embodiments of the invention, the application 114 may be configured to allow for voice commands to be received from the user as the means for selecting the presentation criteria for presentation of impending transaction data on the mobile communication device. For example, voice commands may indicate the type of transactions to be presented, the date range of transactions to be presented, the merchant from which transactions were conducted, the amount range or amount limits of the transactions or the like.

Referring once again to FIG. 2, the transaction presentation application 114 may additionally include automatic launch module 156 which is configured to automatically launch the transaction presentation application 114 and present transaction data 116 upon occurrence of a predetermined event. In one embodiment of the invention, the predetermined event is the user being at or in close proximity to a merchant at which the user has recently conducted a transaction, such as a mobile payment transaction. The automatic launch module 156 may rely on cellular network signals to determine the location of the mobile communication device 102 or the device may include a location determining device, such as a Global Positioning System (GPS) device or the like to determine the location 158 of the mobile communication device 102. The merchants at which the user has recently conducted transactions and their location can be identified from payment databases stored locally on the mobile communication device or remotely at a network site. Once the determination is made that the mobile communication device 102 is located at or in close proximity to a merchant at which the user has conducted a transaction, the application 114 automatically launches and transaction data 116 is displayed. In specific embodiments, the transaction data 116 that is displayed is limited to the merchant that triggered the automatic launch of the application 114.

In other embodiments of the invention, the predetermined event is the user conducting a transaction, such as a mobile payment transaction or the like. Thus, the application 114 may be configured to receive a transaction indication 162 that indicates that the user has immediately conducted a transaction and the merchant 164 associated with the transaction. In the event that the transaction is a mobile payment transaction, the transaction indication 160 may be received from an internal function within the mobile communication device 102. In the event that the transaction is any other transaction other than a mobile payment transaction, the transaction indication 162 is received from an external source, such as a payment processing entity or financial institution. Once the determination is made that the user has immediately conducted a transaction, the application 114 automatically launches and transaction data 116 is displayed. In specific embodiments, the transaction data 116 that is displayed is limited to the merchant 164 at which the immediate transaction was conducted.

In other embodiments of the invention, other predetermined events may trigger the automatic launch of the transaction presentation application 114. For example, account balances falling below a predetermined minimum threshold, budget thresholds being met or exceeded or the like may be predetermined events that trigger the automatic launch of the transaction presentation application 114.

In still further embodiments, the transaction presentation application may include a map generating module 166 configured to generate a map that includes location identifiers for the presented transactions. In such embodiments, the user may have the option of viewing the transaction data 116 in a listing format or in the mapped location format. The mapped location format may be beneficial to the user if the user has re-possessed a lost, stone or misplaced device and the listing of transactions indicates that mobile payment transactions occurred while the device was out of the possession of the user.

As described previously, the transaction data 166 may be presented on an output user interface 128, such as a display, a speaker or the like. The transaction data may include, but is not limited to, the name of the merchant 170, the date and, optionally, time of the transaction 172, the amount of the transaction 174 and any further details 176, such as items included in the transaction, address/contact information of the merchant, and the like.

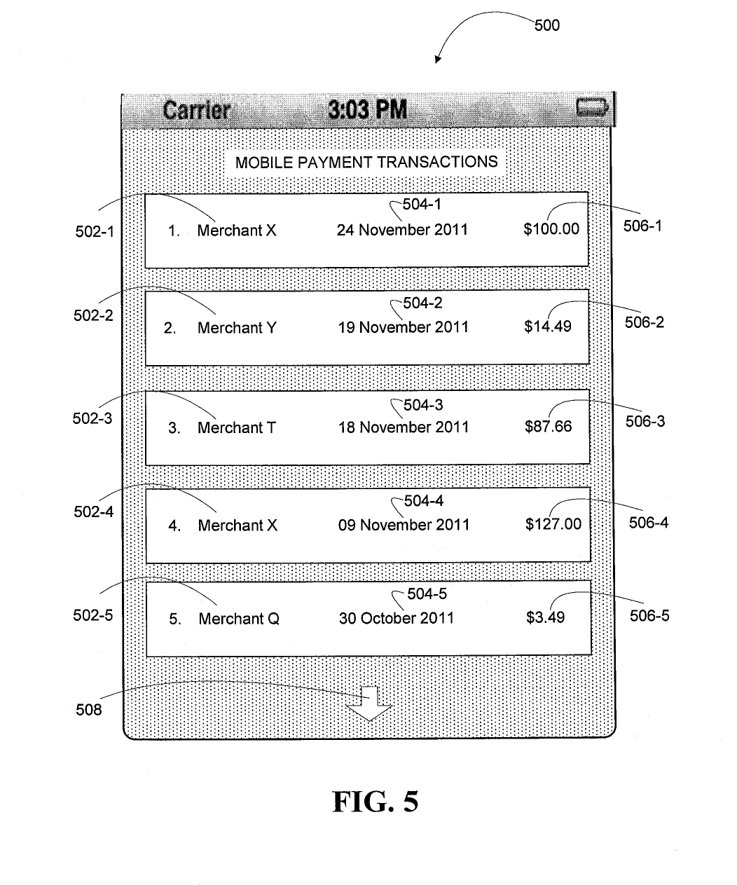

FIG. 5 depicts a graphical representation of a presentation 500 of transaction data on a mobile communication device display in accordance with embodiments of the present invention. The presentation includes transaction data associated with five transactions, specifically the five most recent mobile payment transactions. The transaction data includes the name of merchant 502-1-502-5, the date of the transaction 504-1-504-5 and the amount of the transaction 506-1-506-5. Additional transaction data such the contact information for the merchant, the items in the transaction and the like, may be presented by activating a link associated with the merchant name 502, the date of the transaction 504 and/or the amount of the transaction 506. In the illustrated example of FIG. 5 additional transactions may be presented by activating the down arrow 508 or otherwise scrolling the display.

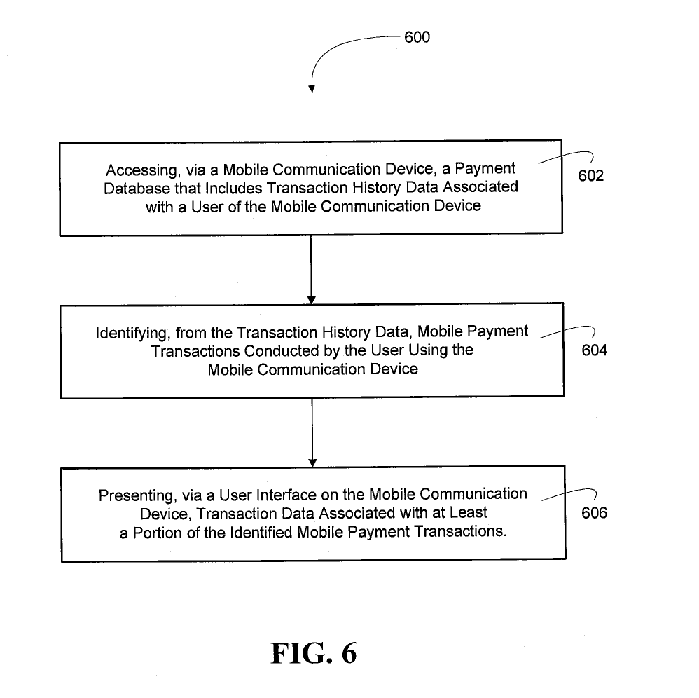

Turning the reader's attention to FIG. 6, a flow diagram is presented of a method 600 for presenting transaction history on a mobile communication device, in accordance with embodiments of the present invention. At Event 602 a payment database is accessed via a mobile communication device. The payment database includes transaction history data associated with a user of the mobile communication device. In specific embodiments the payment database may be specific to a transaction type, such as mobile payment transactions or the like, while in other embodiments the payment database may include multiple transaction types. Further, in specific embodiments the payment database may be remotely accessed at a network entity, while in other embodiments the payment database may be stored locally at the wireless communication device (e.g., a mobile payment database or the like).

Accessing the payment database may occur based on launching of transaction presentation application or the like. The application may be launched based on user input, while in other embodiments of the application may launched (and transaction data presented) automatically based on occurrence of predefined events. The predefined events may be determining that the user is at or near a predetermined location (e.g., a merchant), determining that the user has immediately completed a transaction, determining that an account balances has fallen below predefined minimum balance, determining that budget thresholds have been met or exceeded or the like.

At Event 604, mobile payment transactions, conducted using the mobile communication device, are identified from the transaction history data. In specific embodiments a predetermined number of mobile payment transactions are identified and, more specifically a predetermined number of the most recent mobile payment transactions are identified. The predetermined number of transactions may be configured by the user for continual use or the predetermined number of transactions may be selected by the user for one-time presentation of transaction data.

In further specific embodiments, mobile payment transactions conducted using the mobile communication device at a specific merchant may be identified from the transaction history data. The merchant may be identified by user input, by determining that the user is proximate in location to the merchant and/or determining that a user has immediately conducted at transaction at the merchant.

In additional embodiments of the method, mobile payment transactions within a user-defined date range (or on a specific date) and/or within a user defined price range (or price limit) are identified. In such embodiments the date, date range, price range or price limit may be configured by the user for continual use or the date, date range, price range or price limit may be selected by the user for one-time presentation of transaction data.

Moreover, in other embodiments of the method, other transactions besides mobile payment transactions are identified from the transaction history data. Other transactions may include credit card/account transactions, debit card/account transactions, checking/demand deposit account transactions, pre-paid account transactions and the like. The transaction types identified and presented may be configured by the user for continual use or the transaction types to be identified and presented may be selected by the user for one-time presentation of transaction data.

At Event 606, transaction date associated with at least portion of the identified mobile payment transactions is presented on a user interface of the mobile communication device. The user interface may be a display, a speaker or the like. The transaction data may include, but is not limited to, the name of the merchant, contact information for the merchant, the date/time of the transaction, the amount of the transaction, items in the transaction and the like. Further, the presentation of transaction data may include transaction data related to other transaction types (e.g. credit card/account transactions, debit card/account transactions, checking/demand deposit account transactions, pre-paid account transactions and the like) as designated by the user. Moreover, the presentation of transaction data may be limited to transactions within a user-defined price range or price limit, on or within a user-defined date or date range, conducted at a user-defined merchant or the like. Additionally, in alternate embodiments presenting may further include presenting a map that is configured to indicate the location for each of the identified mobile payment transactions.

Thus, present embodiments disclosed in detail above provide for systems, apparatus, methods and computer program products for providing users/customers instantaneous access to mobile payment transaction history data. As such the mobile payment user can track mobile payment spending and budget accordingly. In addition, embodiments provide for the user to search transaction history to identify specific mobile payment transactions for the purpose of identifying when, where and the amount of a prior mobile payment transaction. Moreover, the user is provided the ability to verify that no unauthorized transactions occurred in the event that the user re-acquires possession of a mobile payment device that was previously lost, stolen or misplaced, or, if unauthorized transactions did occur, the ability to quickly identify the location and amount of such unauthorized transactions.

While the foregoing disclosure discusses illustrative embodiments, it should be noted that various changes and modifications could be made herein without departing from the scope of the described aspects and/or embodiments as defined by the appended claims. Furthermore, although elements of the described aspects and/or embodiments may be described or claimed in the singular, the plural is contemplated unless limitation to the singular is explicitly stated. Additionally, all or a portion of any embodiment may be utilized with all or a portion of any other embodiment, unless stated otherwise.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

1. A method for presenting transaction history on a mobile communication device, the method comprising:
accessing, via the mobile communication device, a payment database that includes transaction history data associated with a user of the mobile communication device;
determining whether a predefined event has occurred, the predefined event comprising (i) the user being at a predefined location, (ii) the user immediately before conducting a transaction, (iii) an account balance falling below a predetermined threshold, or (iv) a budget threshold being exceeded;
based upon whether the predefined event has occurred, automatically identifying, from the transaction history data, mobile payment transactions conducted by the user using the mobile communication device; and
based upon whether the predefined event has occurred, automatically presenting, via a user interface on the mobile communication device, transaction data associated with at least a portion of the identified mobile payment transactions.

2. The method of claim 1, wherein identifying further comprises identifying, from the transaction history data, a predetermined number of mobile payment transactions conducted most recently by the user and presenting further comprises presenting, via a user interface on the mobile communication device, transaction data associated with the predetermined number of mobile payment transactions.

3. The method of claim 1, wherein identifying further comprises identifying, from the transaction history data, mobile payment transactions conducted by the user at a specified merchant and presenting further comprises presenting, via a user interface on the mobile communication device, transaction data associated with at least a portion of the mobile payment transactions conducted by the user at the specified merchant.

4. The method of claim 3, further comprising identifying, via the mobile payment device, the specified merchant by user input.

5. The method of claim 3, further comprising identifying, via the mobile payment device, the specified merchant by determining that the user is proximate in location to the specified merchant.

6. The method of claim 5, wherein determining that the user is proximate in location further comprises implementing, via the mobile communication device, location determination techniques to determine a location of the user.

7. The method of claim 5, wherein determining that the user is proximate in location further comprises determining that the user has immediately before conducted a an in-person transaction at the specified merchant.

8. (canceled)

9. The method of claim 1, wherein identifying further comprises identifying, from the transaction history data, transactions conducted by the user at a specified merchant and presenting further comprises presenting, via a user interface on the mobile communication device, transaction data associated with at least a portion of the transactions conducted via the mobile payment application at the specified merchant.

10. The method of claim 9, further comprising identifying, via the mobile communication device, the specified merchant by user input.

11. The method of claim 9, further comprising identifying, via the mobile communication device, the specified merchant by determining that the user is proximate in location to the specified merchant.

12. The method of claim 11 wherein determining that the user is proximate in location further comprises implementing, via the mobile communication device, location determining techniques to determine the location of the user.

13. The method of claim 11, wherein determining that the user is proximate in location further comprises determining that the user has immediately before conducted a an in-person transaction at the specified merchant.

14. The method of claim 1, wherein identifying further comprises identifying, from the transaction history data, mobile payment transactions occurring over a user-defined date range and presenting further comprises presenting, via a user interface on the mobile communication device, transaction data associated with at least a portion of the mobile payment transactions occurring over the user-defined date range.

15. The method of claim 1, wherein identifying further comprises identifying, from the transaction history data, mobile payment transactions within a user-defined price range or price limit and presenting further comprises presenting, via a user interface at the mobile communication device, transaction data associated with at least a portion of the mobile payment transactions within the user-defined price range or price limit.

16. The method of claim 1, further comprising presenting, via a user interface on the mobile communication device, a map that is configured to indicate a location for each of the identified mobile payment transactions.

17. (canceled)

18. The method of claim 1, wherein accessing further comprises accessing, via the mobile communication device, a payment database stored locally on the mobile communication device.

19. The method of claim 1, wherein accessing further comprises accessing, via the mobile payment device, a payment database stored remotely within a networked device.

20. An apparatus for providing transaction history on a mobile communication device, the apparatus comprising:
a payment database that includes transaction history data associated with a plurality of users; and
a mobile communication device including a memory, at least processor in communication with the memory, a user interface in communication with the memory and processor, a mobile payment application stored in the memory, executable by the processor and configured to act as a payment vehicle for conducting transactions, and a transaction presentation application stored in the memory, executable by the processor and configured to:
access the payment database;
determine whether a predefined event has occurred, the predefined event comprising (i) a user being at a predefined location, (ii) the user immediately before conducting a transaction, (iii) an account balance falling below a predetermined threshold, or (iv) a budget threshold being exceeded;
based upon whether the predefined event has occurred, automatically identify, from the transaction history data, mobile payment transactions conducted by the user using the mobile payment application; and
based upon whether the predefined event has occurred, automatically present, via the user interface, transaction data associated with at least a portion of the identified mobile payment transactions.

21. The apparatus of claim 20, wherein the transaction presentation application is further configured to access the payment database to identify, from the transaction history data, a predetermined number of mobile transactions conducted most recently by the user and present, via the user interface, transaction data associated with the predetermined number of identified mobile payment transactions.

22. The apparatus of claim 20, wherein the transaction presentation application is further configured to access the payment database to identify, from the transaction history data, mobile payment transactions conducted by the user at a specified merchant and present, via the user interface, transaction data associated with at least a portion of the mobile payment transactions conducted by the user at the specified merchant.

23. The apparatus of claim 22, wherein the transaction presentation application is further configured to identify the specified merchant by user input.

24. The apparatus of claim 22, further comprising a location determining device executable by the processor and configured to determine that the user is proximate in location to the specified merchant.

25. The apparatus of claim 24, wherein the transaction presentation application is further configured to automatically launch and provide presentation of the transaction data based on determining that the user is proximate in location to the specified merchant.

26. The apparatus of claim 24, wherein the transaction presentation application is further configured to receive an indication that the user has immediately before conducted an in-person mobile payment transaction at the specified merchant.

27. The apparatus of claim 26, wherein the transaction presentation application is further configured to automatically launch and provide presentation of the transaction data based on receiving an indication that the user has immediately before conducted an in-person mobile payment transaction at the specified merchant.

28. (canceled)

29. The apparatus of claim 20, wherein the transaction presentation application is further configured to access the payment database to identify, from the transaction history data, transactions conducted by the user at a specified merchant and present, transaction data associated with at least a portion of the transactions conducted by the user at the specified merchant.

30. The apparatus of claim 29, wherein the transaction presentation application is further configured to identify the specified merchant by user input.

31. The apparatus of claim 29, further comprising a location determining device executable by the processor and configured to determine that the user is proximate in location to the specified merchant.

32. The apparatus of claim 31, wherein the transaction presentation application is further configured to automatically launch and provide presentation of the transaction data based on determining that the user is proximate in location to the specified merchant.

33. The apparatus of claim 29, wherein the transaction presentation application is further configured to receive an indication that the user has immediately before conducted an in-person transaction at the specified merchant.

34. The apparatus of claim 33, wherein the transaction presentation application is further configured to automatically launch and provide presentation of the transaction data based on receiving an indication that the user has immediately before conducted an in-person transaction at the specified merchant.

35. The apparatus of claim 20, wherein the transaction presentation application is further configured to access the payment database to identify, from the transaction history data, mobile payment transactions occurring over a user-defined date range and present, via the user interface, transaction data associated with at least a portion of the mobile payment transactions occurring over the user-defined date range.

36. The apparatus of claim 20, wherein the transaction presentation application is further configured to access the payment database to identify, from the transaction history data, mobile payment transactions within a user-defined price range or price limit and present, via the user interface, transaction data associated with at least a portion of the mobile payment transactions within the user-defined price range or price limit.

37. The apparatus of claim 20, wherein the transaction presentation application is further configured to present a map that is configured to indicate a location for each of the identified mobile payment transactions.

38. (canceled)

39. The apparatus of claim 20, wherein the payment database is stored locally on the mobile communication device.

40. The apparatus of claim 20, wherein the payment database is stored within a device that is in wireless communication with the mobile communication device.

41. A computer program product, the computer program product comprising a non-transitory computer-readable medium having computer-executable instructions to cause a computer to implement the steps of:
accessing a payment database that includes transaction history data associated with a user of a mobile communication device;
determining whether a predefined event has occurred, the predefined event comprising (i) the user being at a predefined location, (ii) the user immediately before conducting a transaction, (iii) an account balance falling below a predetermined threshold, or (iv) a budget threshold being exceeded;
based upon whether the predefined event has occurred, automatically identifying, from the transaction history data, mobile payment transactions conducted by the user using the mobile communication device; and
based upon whether the predefined event has occurred, automatically presenting, via a user interface on the mobile communication device, transaction data associated with at least a portion of the identified mobile payment transactions.

42. The computer program product of claim 41, wherein the step of identifying further comprises identifying, from the transaction history data, a predetermined number of mobile payment transactions conducted most recently by the user and the step of presenting further comprises presenting, via a user interface on the mobile communication device, transaction data associated with the predetermined number of mobile payment transactions.

43. The computer program product of claim 41, wherein the step of identifying further comprises identifying, from the transaction history data, mobile payment transactions conducted by the user at a specified merchant and the step of presenting further comprises presenting, via a user interface on the mobile communication device, transaction data associated with at least a portion of the mobile payment transactions conducted by the user at the specified merchant.

44. The computer program product of claim 41, wherein the step of identifying further comprises identifying, from the transaction history data, transactions conducted by the user and wherein presenting further comprises presenting, via a user interface on the mobile communication device, transaction data associated with at least a portion of the transactions conducted by the user.

45. The computer program product of claim 44, wherein the step of identifying further comprises identifying, from the transaction history data, transactions conducted by the user at a specified merchant and the step of presenting further comprises presenting, via a user interface on the mobile communication device, transaction data associated with at least a portion of the transactions conducted by the user.

46. The computer program product of claim 41, wherein the step of identifying further comprises identifying, from the transaction history data, mobile payment transactions occurring over a user-defined date range and the step of presenting further comprises presenting, via a user interface on the mobile communication device, transaction data associated with at least a portion of the mobile payment transactions occurring over the user-defined date range.

47. The computer program product of claim 41, wherein the step of identifying further comprises identifying, from the transaction history data, mobile payment transactions within a user-defined price range or price limit and the step of presenting further comprises presenting, via a user interface on the mobile communication device, transaction data associated with at least a portion of the mobile payment transactions within the user-defined price range or price limit.

48. The computer program product of claim 41, wherein the computer-executable instructions cause the computer to implement the further step of presenting, via a user interface on the mobile communication device, a map that is configured to indicate a location for each of the identified mobile payment transactions.

49. (canceled)

50. The computer program product of claim 41, wherein the step of accessing further comprises accessing a payment database stored at one of locally on the mobile communication device or remotely within a networked device.

51. The method of claim 1, wherein:
determining whether a predefined event has occurred comprises determining whether the user has immediately before conducted an in-person transaction at a predefined location;
automatically identifying mobile payment transactions comprises automatically identifying, from the transaction history data, mobile payment transactions conducted by the user at the predefined location using the mobile communication device; and
automatically presenting transaction data comprises automatically presenting, via the user interface on the mobile communication device, transaction data associated with at least a portion of the identified mobile payment transactions conducted by the user at the predefined location.

52. The method of claim 1, wherein determining whether a predefined event has occurred comprises determining whether an account balance associated with the user has fallen below a predetermined threshold.

53. The apparatus of claim 20, wherein determining whether a predefined event has occurred comprises determining whether an account balance associated with the user has fallen below a predetermined threshold.

54. The method of claim 41, wherein determining whether a predefined event has occurred comprises determining whether an account balance associated with the user has fallen below a predetermined threshold.
